(19) United States
(12) Patent Application Publication
(10) Pub. No.: US 2018/0074518 A1
(43) Pub. Date: Mar. 15, 2018

(54) APPARATUS AND METHOD FOR UNMANNED FLIGHT TASK OPTIMIZATION

(71) Applicant: Wal-Mart Stores, Inc., Bentonville, AR (US)

(72) Inventors: Robert L. Cantrell, Herndon, VA (US); John P. Thompson, Bentonville, AR (US); David C. Winkle, Bella Vista, AR (US); Michael D. Atchley, Springdale, AR (US); Donald R. High, Noel, MO (US); Todd D. Mattingly, Bentonville, AR (US); John J. O'Brien, Farmington, AR (US); John F. Simon, Pembroke Pines, FL (US)

(21) Appl. No.: 15/698,467

(22) Filed: Sep. 7, 2017

Related U.S. Application Data
(60) Provisional application No. 62/385,756, filed on Sep. 9, 2016.

(51) Int. Cl. G05D 1/10; B64C 39/02; G05D 1/06

(52) U.S. Cl. CPC G05D 1/101; B64C 2201/18; G05D 1/0676; B64C 39/024

(57) ABSTRACT

Systems, apparatuses and methods are provided herein for unmanned flight optimization. A system for unmanned flight optimization comprises a flight system configured to provide locomotion to an unmanned aerial vehicle, a sensor system on the unmanned aerial vehicle, and a control circuit coupled to the flight system and the sensor system. The control circuit being configured to: retrieve a task profile for a task assigned to the unmanned aerial vehicle, detect condition parameters of the unmanned aerial vehicle based on the sensor system, determine whether to station the unmanned aerial vehicle based on the task profile and the condition parameters, and deactivate the flight system of the unmanned aerial vehicle while the unmanned aerial vehicle performs the task.

### CROSS-REFERENCE TO RELATED APPLICATION

This application claims the benefit of the following U.S. Provisional Application No. 62/385,756 filed Sep. 9, 2016, which is incorporated herein by reference in its entirety.

### TECHNICAL FIELD

This invention relates generally to unmanned aerial systems.

### BACKGROUND

An unmanned aerial vehicle (UAV), also referred to as an aerial drone and an unmanned aircraft system (UAS), is an aircraft without a human pilot aboard.

### BRIEF DESCRIPTION OF THE DRAWINGS

Disclosed herein are embodiments of apparatuses and methods for unmanned flight optimization. This description includes drawings, wherein:

FIG. 1 is a system diagram of an overall system in accordance with several embodiments;

FIG. 2 is a flow diagram of a method in accordance with several embodiments;

FIG. 3 is a block diagram of a system in accordance with several embodiments;

FIG. 4 is a flow diagram of a method in accordance with several embodiments;

FIG. 5 is a flow diagram of a method in accordance with several embodiments;

FIG. 6 is a flow diagram of a method in accordance with several embodiments;

and

FIG. 7 is a flow diagram of a method in accordance with several embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein for unmanned flight optimization. In some embodiments, a system for unmanned flight optimization comprises a flight system configured to provide locomotion to an unmanned aerial vehicle, a sensor system on the unmanned aerial vehicle, and a control circuit coupled to the flight system and the sensor system. The control circuit being configured to: retrieve a task profile for a task assigned to the unmanned aerial vehicle, detect condition parameters of the unmanned aerial vehicle based on the sensor system, determine whether to station the unmanned aerial vehicle based on the task profile and the condition parameters, and deactivate the flight system of the unmanned aerial vehicle while the unmanned aerial vehicle performs the task.

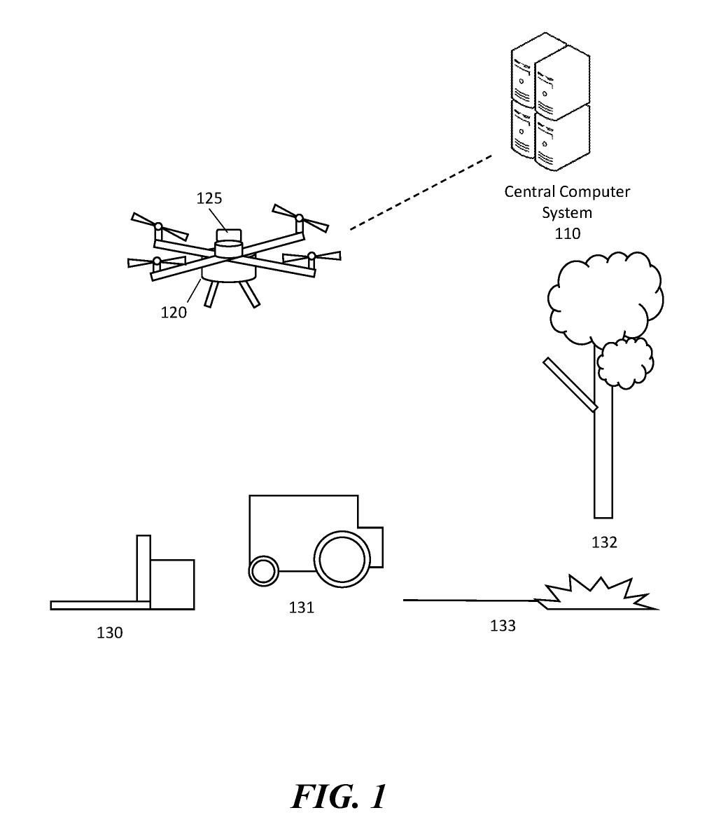

Referring now to FIG. 1, a system for performing tasks with UAV according to some embodiments is shown. The system includes a central computer system 110 configured to communicate with a UAV 120 comprising a sensor device 125. The UAV 120 may be configured to land and/or dock at one or more types of landing locations such as a docking station 130, a vehicle 131, an elevated location 132, and the ground 133.

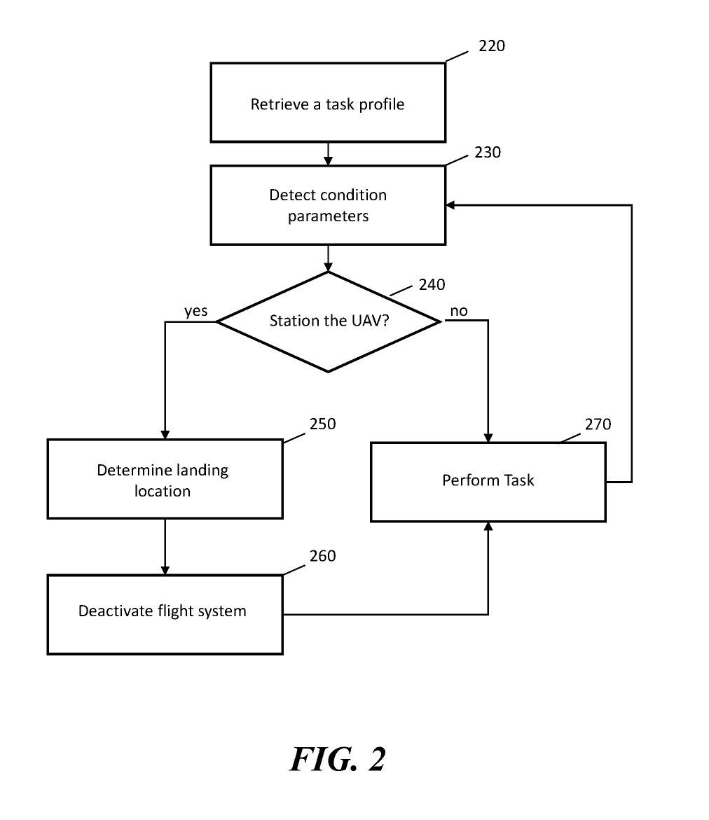

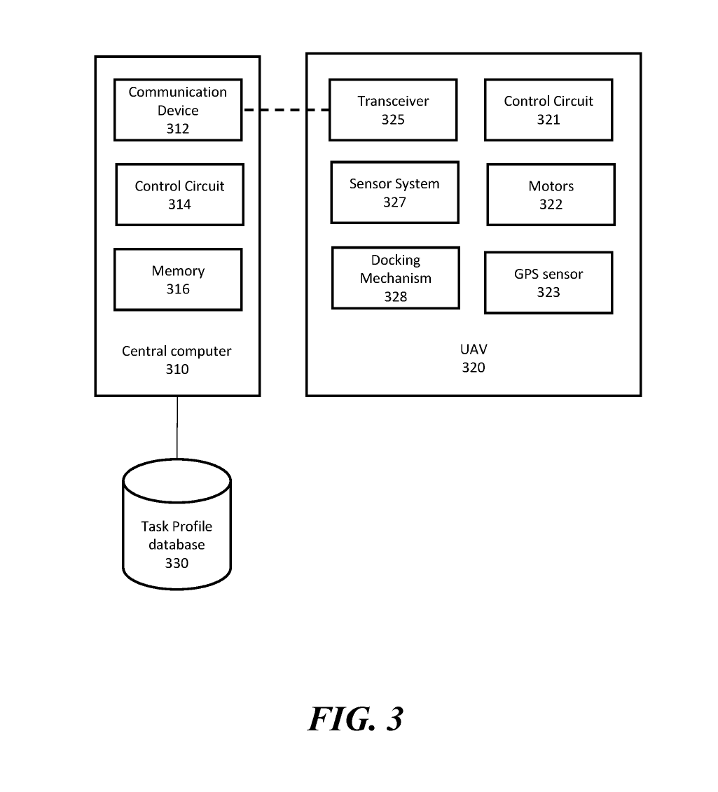

The central computer system 110 may comprise a control circuit, a central processing unit, a processor, a microprocessor, and the like and may be one or more of a server, a central computing system, a UAV management computer system, a personal computer system, and the like. Generally, the central computer system 110 may comprise any processor-based device configured to communicate with UAVs. In some embodiments, the central computer system 110 may comprise a system that is remote to a task site, a system that is at least partially located at the task site, and/or a cloud-based system. The central computer system 110 may comprise a processor configured to execute computer readable instructions stored on a computer readable storage memory. The central computer system 110 may generally be configured to cause the UAV 120 perform a task. In some embodiments, the central computer system 110 may be configured to determine whether to station the UAV to perform a task based on sensor readings. In some embodiments, the central computer system 110 may further be configured to select a landing location for the UAV 120. In some embodiments, the central computer system 110 may perform one or more steps in the methods and processes described with reference to FIG. 2 herein. Further details of a central computer system 110 according to some embodiment is provided with reference to FIG. 3 herein.

The UAV 120 may generally comprise an unmanned aerial vehicle comprising a sensor device 125 and configured to perform one or more tasks. In some embodiments, the UAV 120 may comprise a multicopter configured to hover at and/or near a task premises. In some embodiments, the UAV 120 may comprise a quadcopter, or hexacopter, octocopter, etc. In some embodiments, the UAV 120 may comprise an air chamber (e.g. balloon, blimp, etc.) storing lighter than air gas for providing lift to the UAV 120. In some embodiments, the UAV 120 may comprise flexible wings configured to allow the UAV 120 to glide in the air. In some embodiments, the UAV 120 may comprise a communication device configured to communicate with the central computer system 110 before and/or during flight, a GPS receiver configured to provide geolocation information of the UAV 120, and a control circuit configured to control the navigation and task performance of the UAV 120.

The sensor device 125 may comprise one or more sensors for capturing data from the environment of the UAV 120. In some embodiments, the sensor device 125 comprises one or more environmental sensors such as wind sensor, light sensor, image sensor, visibility sensor, weather sensor, barometric pressure sensor, range sensor, humidity sensor, sound sensor, thermal image sensor, night vision camera, etc. In some embodiments, the sensor device 125 may further be configured to collect data specified by one or more tasks assigned to the UAV 120. In some embodiments, the UAV 120 may include other flight sensors such as optical sensors and radars for detecting obstacles in the path of flight to avoid collisions. In some embodiments, the sensor device 125 may comprise one or more detachable modular components comprising one or more sensors. In some embodiments, the sensor device 125 may comprise one or more devices attached to the UAV's body through one or more attachment means and/or may be integrated with the body of the UAV 120. In some embodiments, one or more sensors may be coupled to an actuator that pivots and/or rotates the sensor relative to the body of the UAV 120. While the sensor device 125 unit is shown to be attached to the top of the UAV 120 in FIG. 1, in some embodiments, sensors may be attached to different portions of the UAV (e.g. top, wing, landing gear, etc.). In some embodiments, the sensor device 125 may comprise a standalone device that may operate independently when detached from the UAV 120. In some embodiments, the UAV 120 may be configured to drop one or more detachable sensor devices at a task site for data gathering.

In some embodiments, the UAV 120 may be configured to perform one or more types of task. In some embodiments, the tasks may relate to one or more of agriculture, farming, livestock management, geological survey, scientific study, wildlife study, wildlife management, security surveillance, forestry, marine study, etc. In some embodiments, tasks may comprise data gathering tasks and/or action tasks in which UAV 120 acts to affect the environment, animals, and/or persons around it. In some embodiments, tasks may be performed with one or more modular attachments to the UAV 120. In some embodiments, two or more UAVs may be configured to collectively perform a task. Further details of a UAV 120 according to some embodiments is provided with reference to FIG. 3 herein.

In some embodiments, the UAV 120 may be configured to land on a variety of landing locations. In some embodiments, the UAV 120 may be configured to dock with a docking station 130. In some embodiments, the docking station 130 may be configured to recharge the UAV 120, store and/or process data gathered by the UAV 120, perform diagnostics on the UAV 120, attached and/or detach UAV modules, and/or serve as a communication hub for a plurality of UAVs. In some embodiments, the UAV 120 and the docking station may comprise complimentary mechanical coupling means for securing the UAV 120 to the docking station 130. In some embodiments, the docking station 130 may comprise solar panels and/or power grid connections for providing power to the docking station 130. In some embodiments, the UAV 120 may be configured to land on a vehicle 131. In some embodiments, the vehicle 131 may comprise a docking station similar to the docking station 130. In some embodiments, the vehicle 131 may comprise a human-operated or unmanned vehicle. In some embodiments, the vehicle 131 may comprise farm equipment such as a tractor, a harvester, a seeder, a haymaker, etc. In some embodiments, the vehicle 131 may also be configured to receive tasks and/or instructions from the central computer system 110. In some embodiments, the UAV 120 may be configured to land on a vehicle 131 in motion and perform tasks while riding on a moving vehicle. In some embodiments, the UAV 120 may be configured to run diagnostics and/or perform repairs on the vehicle 131 while docked to the vehicle 131. In some embodiments, the UAV 120 may be configured land on the ground 133. In some embodiments, the ground 133 may refer to any surface with enough clearance for UAV 120 to land. In some embodiments, the UAV 120 may be configured to land on an elevated location 132 such as a tree branch, a utility pole, a building, a UAV platform, etc. In some embodiments, an elevated location 132 may comprise a docking station similar to the docking station 130.

While only one UAV 120 is shown in FIG. 1, in some embodiments, the central computer system 110 may communicate with and/or provide task instructions to a plurality of UAVs. In some embodiments, two or more UAVs may be deployed at a task site to perform complimentary and/or parallel tasks simultaneously and/or in shifts. In some embodiments, the UAVs may be configured to communicate directly with each other and/or via a docking station 130 or other communication devices in the field. In some embodiments, central computer system 110 may assign tasks to UAVs based on one or more of the locations of UAVs, locations of task targets, other tasks already assigned to UAVs, capabilities of each UAV, fuel level of each UAV, current attachments of each UAV, etc.

Referring now to FIG. 2, a method of optimizing unmanned flight is shown. In some embodiments, the steps shown in FIG. 2 may be performed by a processor-based device, such as the central computer system 110, the controls of the UAV 120 described with reference to FIG. 1, the control circuit 314 and/or the control circuit 321 described with reference to FIG. 3 below. In some embodiments, the steps may be performed by one or more of a processor of a UAV, a processor of a central computer system, a processor of a docking station, and/or a processor device on the ground of the UAV task site.

In step 220, the system retrieves a task profile for a task assigned to a UAV. In some embodiments, the task may be assigned by a remote central computer system. In some embodiments, the task and/or task profile may be preloaded on the UAV prior to the UAV's deployment to a site. In some embodiments, the task profile may be retrieved from the UAV's local memory device, via a wired or wireless data connection, via a docking station, and/or from another processor-based device. In some embodiments, a task profile comprises one or more requirements for task accuracy, acceptable risk, distance to a task location, data to be collected, action to be performed, and required modular attachments. In some embodiments, multiple task profiles for tasks assigned to the UAV may be retrieved in step 220. In some embodiments, the task profile may be retrieved from the task profile database 330 described with reference to FIG. 3 herein.

In step 230, the system detects condition parameters. In some embodiments, condition parameters may be detected by a sensor system on the UAV. In some embodiments, condition parameters may comprise one or more of: wind speed, visibility, lighting condition, precipitation, weather condition, ground condition, landing site availability, animal presence, human presence, and distance to a charging station. In some embodiments, condition parameters may be detected by one or more sensors on the UAV. In some embodiments, the sensor system may comprise one or more environmental sensors such as wind sensor, light sensor, image sensor, visibility sensor, weather sensor, barometric pressure sensor, range sensor, humidity sensor, sound sensor, thermal image sensor, night vision camera, etc. In some embodiments, the condition parameters detected in step 230 may be specified by the task profile retrieved in step 220. For example, the UAV may selectively turn on one or more sensors to collect environmental data that is relevant to the requirements of the task profile. In some embodiments, the condition parameters may be detected by the sensor device 125 described with reference to FIG. 1, the sensor system 327 described with reference to FIG. 3, or other similar devices. In some embodiments, step 230 may be performed while the UAV is in flight or stationed.

In step 240, the system determines whether to station the UAV. Stationing the UAV may generally refer to landing and/or grounding the UAV. In some embodiments, step 240 may be performed based on the task profile retrieved in step 220 and the condition parameters detected in step 230. In some embodiments, whether to station the UAV may be determined based on satisfying the requirements of the task profile while minimizing power consumption of and risk to the unmanned aerial vehicle. In some embodiments, whether to station the unmanned aerial vehicle may be determined further based on one or more of a fuel level, attached equipment type, flight capability, other assigned tasks of the unmanned aerial vehicle, and tasks assigned to a system of manned or unmanned vehicles. In some embodiments, the system may determine whether the requirements of the task profile could be met with the UAV stationed at a location under the current condition. In some embodiments, the system may be configured to estimate the cost of fuel for flying the UAV to perform the task based on condition parameters and/or the task profile. For example, the length of flight required, the current wind speed and direction, and the equipment to be carried on the UAV may be factors in the cost of flying the UAV. In some embodiments, the system may be configured to estimate the risk to the safety of the UAV for flying the UAV to perform the task based on condition parameters. For example, the current wind speed, the current weather, the presence of nearby animals and/or humans may be factors in calculating the risk of flying the UAV. In some embodiments, the system may further consider the availability of landing locations and/or characteristics of potential landing locations. In some embodiments, the system may consider whether the task may be performed with the travel path of a land vehicle (e.g. car, tracker, farm equipment, etc.). In some embodiments, the travel path of the land vehicle may comprise pre-planned path of unmanned or manned vehicles. In some embodiments, the system may be configured to cause a land vehicle to travel in a pattern to carry the UAV for a task.

In some embodiments, the system may separately evaluate each of the requirements in the task profile based on the condition parameters detected by the sensor system to determine whether each requirement could be met. For example, a task profile may require visibility of at least 30% of a plot of land and the system may determine whether the required visibility may be achieved from one or more landing locations for the UAV. In another example, the task profile may require that the UAV maintain a set distance from a stationary or moving task target and the system may determine whether the required distance may be maintained with the UAV stationed at one or more landing locations. In some embodiments, task requirements may be weighed against energy savings and/or potential risk in determining whether to station the UAV. For example, the amount of time saved from performing the task in flight may be weighed against the amount of energy saved from performing the task while stationed. In another example, the effectiveness of a moving pest deterring sound maker as compared a stationary pest deterring sound maker may be weighed against the increased risk of flying the UAV near pests. In yet another example, the accuracy of data collected while in flight may be weight against the cost for flying the UAV in the current wind condition. In some embodiments, one or more requirements of the task profile may comprise an absolute requirement that only allow the UAV to perform the task while stationed if the requirements can be met. In some embodiments, one or more requirements of the task profile may comprise cost and benefit factors that may be weighed against each other. In some embodiments, the system may station the UAV if the cost of flight (e.g. added energy cost, added risk) outweighs the benefit of flight (e.g. increased speed, increased accuracy, effectiveness, etc.) for the performing task. In some embodiments, the UAV may be configured to perform tasks while stationed unless at least one requirement of the task profile cannot be met while stationed. In some embodiments, if the risk to the UAV exceeds a set threshold, the system may ground the UAV regardless of the requirements of the task profile. For example, the system may ground a UAV and temporary suspend task performances during a severe storm. In some embodiments, if at least one task assigned to the UAV requires flight, the system may cause the UAV to fly and simultaneously perform one or more tasks that may or may not require flight. In some embodiments, the system may be configured to reassign tasks that require flight to UAVs already in flight or scheduled for flight.

If the system determines to not station the UAV to perform the task, in step 270, the UAV performs the task while in flight. In some embodiments, the system may further determine a flight pattern for the UAV in step 270 based on the task profile and/or condition parameters. In some embodiments, if the UAV is currently stationed, the UAV may cause the flight system of the UAV to lift and steer the UAV to perform the task.

If the system determines to station the UAV to perform the task, in step 250, the system may further select a landing location for the UAV. In some embodiments, the landing location may comprise one or more of a docking station, a charging station, a ground location, an elevated observation location, and a motored vehicle. In some embodiments, the system may select two or more landing locations to complete a task. For example, a data collection task may use two or more landing locations to provide sufficient coverage of an area. In some embodiments, the landing locations may be selected based on one or more of the task requirements, the condition parameters, the locations of the landing locations, the locations of one or more target areas of the task, elevation of the landing locations, capabilities of landing locations, etc. In some embodiments, a landing location with a recharging station may be prioritized if the UAV is low on power. In some embodiments, the system may rate a plurality of landing locations based at least on the requirements of the task profiles to select one or more landing locations for the UAV. In some embodiments, if the UAV is currently stationed, the system may evaluate whether the task may be performed to requirement at the current location. In some embodiments, the cost of flying the UAV to a second location for landing may be weighed against the benefit of performing the task at the second location as compared to the current location. In some embodiments, if the UAV is currently stationed, the system may cause the UAV to fly to the selected landing location. In some embodiments, if the UAV is currently in flight, the system may cause the UAV to land at a selected landing location.

In step 260, the system deactivates the flight system of the UAV at the landing location. In some embodiments, the flight system may comprise one or more of motors, propellers, navigation sensors, location sensors, wings, and communication device of the UAV. In some embodiments, the UAV may selectively turn off one or more components of the flight system not needed to perform the assigned task to conserve energy while the task is carried out. In step 270, the UAV performs the task with the flight system deactivated. In some embodiments, the UAV may be configured to simultaneously perform multiple tasks in-flight and/or stationed.

In some embodiments, during the performance of the task in step 270, the system may be configured to detect updated condition parameters and return to step 230 to determine whether to station the UAV based on the updated condition parameters. For example, if a stationed UAV's visibility is considerably reduced (e.g. fog rolls in) the system may determine to fly the UAV to gather the data required to complete the task. In another example, if a task target (e.g. farm animal, worker) becomes stationary for a prolonged period of time, the system may determine to station the UAV nearby until the target begins to move again. In some embodiments, the system may further select a new landing location based on the updated condition parameters similar to step 250.

Referring now to FIG. 3, a block diagram of a system for unmanned flight optimization is shown. The system includes a central computer system 310, a UAV 320, and a task profile database 330.

The central computer system 310 comprises a communication device 312, a control circuit 314, and a memory 316. The central computer system 310 may comprise one or more of a server, a central computing system, a UAV management computer system, and the like. In some embodiments, the central computer system 310 may comprise the central computer system 110 in FIG. 1 or a similar device. In some embodiments, the central computer system 310 may comprise a system of two or more processor-based devices. The control circuit 314 may comprise a processor, a microprocessor, and the like and may be configured to execute computer readable instructions stored on a computer readable storage memory 316, The computer readable storage memory 316 may comprise volatile and/or non-volatile memory and have stored upon it a set of computer readable instructions which, when executed by the control circuit 314, cause the system to manage tasks carried out by UAVs 320. In some embodiments, the computer executable instructions may cause the control circuit 314 of the central computer system 310 to perform one or more steps described with reference to FIG. 2 herein.

The central computer system 310 may be coupled to a task profile database 330 via a wired and/or wireless communication channel. In some embodiments, the task profile database 330 may be at least partially implemented with the memory 316 of the central computer system 310. The task profile database 330 may have stored on it a plurality of task profiles associated with different types of tasks and/or task locations. In some embodiments, task profiles may comprise one or more requirements for task accuracy, acceptable risk, distance to a task location, data to be collected, action to be performed, and required modular attachments. In some embodiments, the requirements may correspond to one or more condition parameters comprising one or more of: wind speed, visibility, lighting condition, precipitation, weather condition, ground condition, landing site availability, animal presence, human presence, and distance to a charging station. In some embodiments, one or more tasks in the task profile database 330 may always require flight or always require the UAV to be stationed during the performance of the task. In some embodiments, one or more tasks in the task profile database 330 may be performed while the UAV is stationed if the requirements of the task can be met. In some embodiments, one or more tasks in the task profile database 330 may be performed while the UAV is in flight if the benefit of the performing the task with the UAV in flight outweigh the cost and risk of flying the UAV. In some embodiments, factors for calculating cost and benefit of flight may be part of the task profile and/or separately stored. In some embodiments, the task profile may specify the weighting factors and/or thresholds for different types of costs and benefits relating to the task.

In some embodiments, the central computer system 310 may further be coupled to or include a UAV database configured to record statuses of UAVs managed by the central computer system 310. States of UAVs may comprise one or more of each UAV's location, assigned task(s), sensor reading, current attachments, capabilities, and/or fuel level. In some embodiments, the central computer system 310 may use the UAV database to assign new tasks, provide task instructions to UAVs, and coordinate a system of UAVs at a task site.

The UAV 320 may comprise an unmanned aerial vehicle configured to travel and land to perform a variety of tasks. In some embodiments, the UAV 320 may comprise a multicopter configured to hover at or near a target location and/or object. For example, the UAV 320 may comprise a quadcopter, or hexacopter, octocopter, etc. In some embodiments, the UAV 320 may comprise an air chamber (e.g. balloon, blimp, etc.) storing lighter than air gas for providing lift to the UAV 320. In some embodiments, the UAV 320 may comprise flexible wings configured to allow the UAV 320 to glide in the air. In some embodiments, the UAV 320 may comprise the UAV 120 described with reference to FIG. 1 or a similar device. The UAV 320 comprises a control circuit 321, motors 322, a GPS sensor 323, a transceiver 325, a sensor system 327, and a docking mechanism 328.

The control circuit 321 may comprise one or more of a processor, a microprocessor, a microcontroller, and the like. The control circuit 321 may be communicatively coupled to one or more of the motors 322, the GPS sensor 323, the transceiver 325, the sensor system 327, and the docking mechanism 328. Generally, the control circuit 321 may be configured to navigate the UAV 320 and cause the UAV 320 to perform tasks.

The motors 322 may comprise motors that control one or more of a speed and/or orientation of one or more propellers on the UAV 320. The motors 322 may be configured to be controlled by the control circuit 321 to lift and steer the UAV 320 in designated directions. The GPS sensor 323 may be configured to provide GPS coordinate to the control circuit 321 for navigation. In some embodiments, the UAV 320 may further include an altimeter for providing altitude information to the control circuit 321 for navigation.

The transceiver 325 may comprise one or more of a mobile data network transceiver, a satellite network transceiver, a WiMax transceiver, a Wi-Fi transceiver, a Bluetooth transceiver, a RFID reader, and the like. In some embodiments, the transceiver 325 may be configured to allow the control circuit 321 to communicate with the central computer system 310, another UAV, a docking station, and/or a deployed sensor device. In some embodiments, the transceiver 325 may maintain at least periodic communication with the central computer system 310 while the UAV 320 travels and performs tasks. In some embodiments, the UAV 320 may be configured to autonomously travel and perform tasks for extended periods of time without communicating with a remote system. In some embodiments, the flight system of the UAV may refer to one or more of the motors 322, the GPS sensor 323, and the transceiver 325 of the UAV.

The sensor system 327 may comprise one or more navigation and/or data collection sensors. The sensor system 327 may comprise one or more sensors for capturing data from the environment of the UAV 320. In some embodiments, the sensor system 327 may comprise one or more environmental sensors such as wind sensor, light sensor, optical sensor, visibility sensor, weather sensor, barometric pressure sensor, range sensor, humidity sensor, sound sensor, thermal image sensor, night vision camera, etc. In some embodiments, the sensor system 327 may be configured to collect data specified by one or more tasks assigned to the UAV 320. In some embodiments, the sensor system 327 may include other flight sensors such as optical sensors and radars for detecting obstacles in the path of flight to avoid collisions. In some embodiments, the sensor system 327 may comprise one or more detachable modular components comprising one or more sensors. In some embodiments, the sensor system 327 may comprise one or more devices attached to the UAV's body through one or more attachment means and/or may be integrated with the body of the UAV 320. In some embodiments, the UAV 320 may be configured to deploy one or more detachable sensor device at a task site for data gathering.

The docking mechanism 328 may comprise mechanical and/or electrical connections for docking the UAV 320 to another device. In some embodiments, the docking mechanism 328 may comprise a securing mechanism for anchoring the UAV 320 to a landing surface such as soil, grass, tree branch, docking station, vehicle, etc. In some embodiments, the docking mechanism 328 may comprise electrical connections for exchanging data between the UAV 320 and a docking station and/or a vehicle. In some embodiments, the docking mechanisms 328 may comprise electrical connections for recharging a power source of the UAV 320. In some embodiments, the UAV 320 may further comprise a power source such as a rechargeable battery, a replaceable battery, a fuel cell, a fuel tank, solar cells, etc.

In some embodiments, the system may further comprise one or more docking stations. In some embodiments, a docking station may be configured to recharge the UAV 320, store and/or process data gathered by the UAV 320, perform diagnostics on the UAV 320, attached and/or detach modules or batteries to the UAV 320, and/or serve as a communication hub for a plurality of UAVs. In some embodiments, a docking station may comprise a control circuit, a memory, and/or a communication device for communicating with UAVs and/or the central computer system 310. In some embodiments, the central computer system 310 may be at least partially implemented on one or more docking stations or another processor based device at the task site. In some embodiments, a docking station may be located on the ground, on a vehicle, on a building, on a structure, and/or on an elevated platform.

While only one UAV 320 is shown in FIG. 3, in some embodiments, the central computer system 310 may communicate with and/or control a plurality of UAVs. In some embodiments, the central computer system 310 may coordinate the task performances of two or more UAVs deployed to the same task site. For example, two or more UAVs may collect data from different angles and locations to obtain a complete data set for an area. In some embodiments, two or more UAVs may perform tasks in shifts. In some embodiments, the central computer system 310 may be configured to adjust the requirements of the task profiles in the task profile database 330 based on the data collected by UAVs under different condition parameters.

In some embodiments, task profiles in a task profile database may be weighted and tiered based on the task criticality. For example, the tasks may be categorized as being extremely critical, critical, neutral, secondary, or non-critical. In some embodiments, task information in a task profile may comprise docking conditions. The docking conditions may specify whether a task may be performed while docked or must be performed while undocked. In some embodiments, the task profile may specify the conditions under which performing the task while docked is permitted.

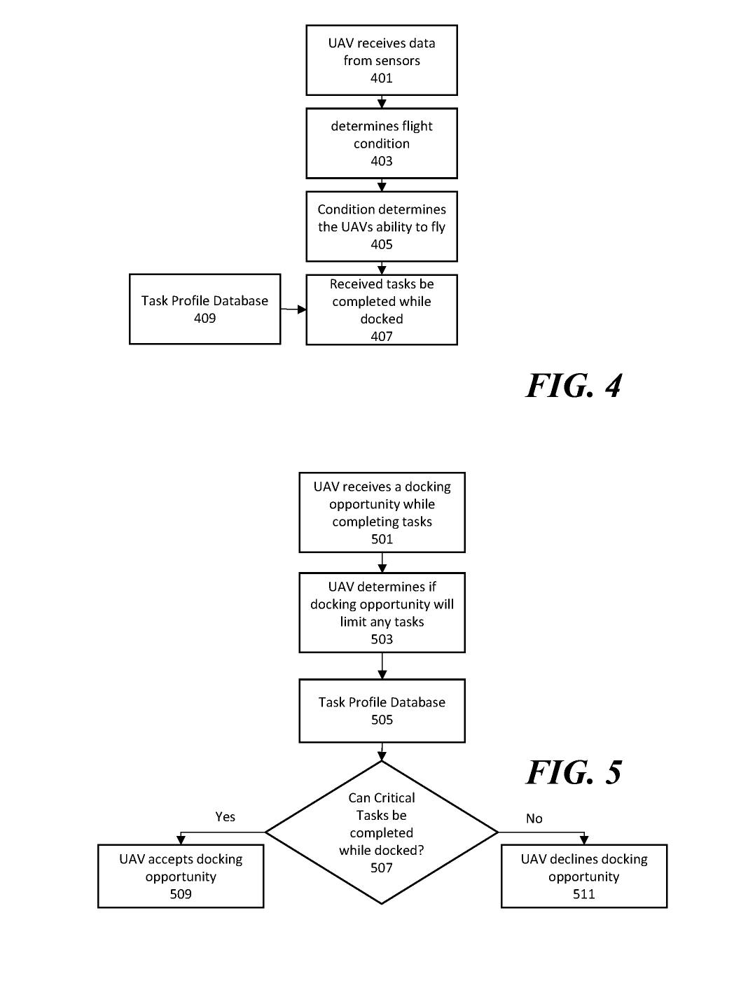

Referring now to FIG. 4, a flow diagram of UAV flight control is shown. The steps in FIG. 4 may be used to dynamically decide whether a task should be performed while the UAV is in flight or docked. In step 401, the UAV receives data from on broad and/or remote sensors. In step 405, the UAV uses the sensors to determine flight condition. In step 405, the system determines the UAV's ability to fly and perform the task based on the flight condition. If the UAV is not able to fly at this time, the UAV may receive tasks that may be performed while the UAV is docked in step 407. The task profiles may be retrieved from the task profile database 409.

Referring now to FIG. 5, a flow diagram of UAV flight control is shown. The steps in FIG. 5 may be used to dynamically assess opportunities to dock a UAV to perform a task. In step 501, the UAV receives a docking opportunity while completing tasks. In some embodiments, a docking opportunity may comprise a docking station, a charging station, a landing pad, etc. being nearby. In step 503, the UAV determines if the docking the UAV will limit its ability to perform one or more assigned tasks. In step 505, the system queries the task profile database to retrieve the profile of an assigned task. In step 507, the system determines whether a task that is marked as being critical may be completed while docked. In some embodiments, the system may determine whether it is critical for the task to be performed in flight. If the task may be performed while the UAV is docked, in step 506, the UAV accepts the docking opportunity and initiate landing. If the task is required to be performed while in flight, in step 511, the system declines the docking opportunity and continue to perform tasks in flight.

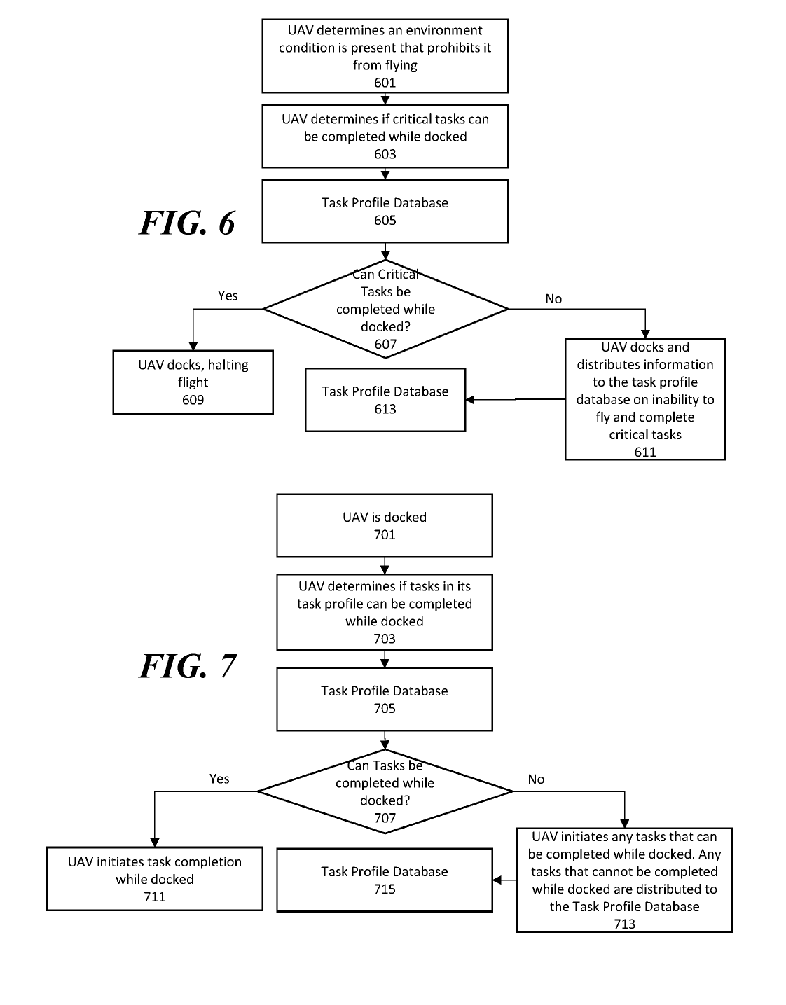

Referring now to FIG. 6, a flow diagram of UAV flight control is shown. The steps in FIG. 6 may be used when environment conditions require the UAV to dock for safety. In step 601, the UAV detects that the environmental condition prohibits flight. In some embodiments, step 601 may be based on whether the UAV's flight system may maintain control of the UAV and avoid damages under the current condition. In step 603, the UAV determines if a critical task can be completed while the UAV is docked. In step 605, the UAV queries the task profile database. In step 607, the system determines whether the critical tasks can be completed while the UAV is docked. If so, the UAV docks in step 609. If not, the UAV docks and updates the task profile database 613 to record its inability to fly and complete the critical task. In some embodiments, the task may be reassigned to another UAV. In some embodiments, the task may be resumed by the same UAV at a later time.

Referring now to FIG. 7 a flow diagram for UAV flight control is shown. The steps in FIG. 7 may be used to determine whether a task can be completed while the UAV is docked. In step 701, the UAV is docked. In step 703, the UAV determines whether its assigned tasks can be completed while docked based on the task information stored in the task profile database. In step 707, if the task can be completed while docked, the UAV performs the task while docked in step 711. If the task cannot be completed while docked, the UAV performs any other tasks that can be completed while docked. Tasks that cannot be performed may be redistributed to other vehicles via the task profile database 715.

Non-limiting examples of tasks that may be carried out by UAVs and functionalities of UAVs are provided herein. In some embodiments, a UAV may be configured to dock with one or more of a field equipment, an autonomous vehicle, a stationary docking station, and a moving vehicle or equipment. In some embodiments, the system may use the parameters of a task to determine whether to perform the task while stationary, docked, moving, and/or undocked. In some embodiments, a task profile may specify an accuracy of the task and the system may determine whether the accuracy could be achieved while the UAV is docked or undocked. In some embodiments, the system may consider the optimization of one or more of the UAV, field equipment, and sensors in completing a task. In some embodiments, the system may consider the window of opportunity for performing the task. For example, a UAV assigned to perform night scouting may require the UAV to fly in a scouting pattern during a set period of time. In some embodiments, the system may consider whether to station the UAV based on energy efficiency. For example, the system may consider whether there is equipment in the field that can carry the UAV around while the UAV performs the assigned task. In some embodiments, the system may assess the risk that the task presents to the UAV, equipment, or persons in the field. For example, in high winds or high rains, the system may cause the UAV to dock at a station and complete the tasks from a fixed location. In some embodiments, the risks associated with given tasks and environment may be weighted heavily in the consideration as compared to other parameters and requirements.

In some embodiments, the decision making for the UAV may be logic dynamic and localized. For example, a UAV may be configured to make decisions in the field with logical values already defined. In some embodiments, UAVs may further be configured to assign tasks to field equipment. In some embodiments, UAVs may be configured to make decisions based on their existing missions and data received from sensors and/or a remote data source.

In some embodiments, a decision-making system may use tasks assigned to a UAV, including rules and parameters, to determine whether to dock, undock, or fly the UAV. In some embodiments, the system may consider sensor data, required equipment, task criterion, fuel level, system optimization, equipment optimization, task optimization, and field optimization in the decision making. In some embodiments, a UAV may be configured to mission plan and making changes to equipment's missions while it is docked.

In some embodiments, a UAV may be configured to use the docking station for data processing, data storage, communication with equipment, refueling, retooling, etc. In some embodiments, a UAV may use the docking station to process the data received from its own sensors and/or the sensors on other equipment. In some embodiments, a UAV may be configured to use the docking station to store the data. In some embodiments, a UAV may be configured to use the docking station to communicate with other equipment in the field, a central computer system, and/or one or more persons operating or working with the system. In some embodiments, a UAV may use the docking station to retool its integrated devices, such as removing/adding modular adapters for various sensors. In some embodiments, sensors may include soil monitors, weather monitors, pest monitors, etc. In some embodiments, the system may comprise modular sensors configured to be dropped from the UAV, and monitor the given area via ongoing active communication, and then picked up by the UAV. In some embodiments, a UAV may replenish its power source at the docking station through one or more of electromagnetic induction, automated battery swapping, plug-and-play recharging, radio frequency induction, etc.

In some embodiments, a UAV may be configured perform a variety of tasks while landed. In some embodiments, a UAV may be configured to collect information and data from a onboard sensor, remote sensors, and other equipment. In some embodiments, a UAV may be configured to exchange data with a docking station. In some embodiments, a UAV may perform visual analysis using its own visual system or other equipment. In some embodiments, a UAV may process data using an onboard data processors and/or a data processor of the docking stations.

In some embodiments, if a UAV is docked on a given piece of equipment, the UAV may be configured to function as a diagnostic tool for the equipment. In some embodiments, a UAV may transmit equipment errors to a central computer system, an operator, a docking station, or other equipment. In some embodiments, a UAV may be configured to perform repair service on the equipment based on the detected errors.

In some embodiments, a system tracks and manages the seed to sale process of fresh produce. The process may start from seed, to growth, to harvest, to long distance transport, to last-mile transport, to point of sale, including storage points along the way ranging from bulk stores and store shelves. Efficient management of such process may get fresh produce to a buyer at a point of sale with ample return from investment and increase customer satisfaction. In some embodiments, the system may be configured to use UAVs and other sensor data for risk reduction. In some cases, the greatest risk of investment corresponds to when a farmer plants a seed and the least risk occurs at the point of sale when a customer has the fresh produce in hand. In some embodiments, UAV data may be analyzed along with other data to reduce the risk. For example, a UAV may be used to determine optimal planting conditions weighed against the optimal window for planting in the region—a period of high uncertainty. In another example, a UAV may be used to determine optimal harvest times weighed against near-term weather—a period of lower uncertainty. In some embodiments, data used for system management may be repurposed in the futures markets to further offset risks.

In some embodiments, reducing risks at different stages of the seed to sale process allows algorithms to give freshness-at-an-ample-margin a higher priority than simple efficient logistics. Having a higher percentage of produce successfully grown reach customers can offset the marginally higher cost of implementing the system. The costs may further be reduced by the higher number of satisfied customers that return to their point of sale. Transport and storage cost may also be calculated to increase the efficiency of the system.

With the system, the risk of loss from seed to sale may track downward as each hurdle (risk generating event) is successfully crossed. In some embodiments, UAV data may be used to flag whenever the risk tracks the wrong way. For example, oversupply that could lead to produce spoilage could be offset by an adjustment elsewhere in the system. In another example, the system may detect that a region needs more transport capacity to move the expected volume of harvest faster. In some embodiments, with the system, UAV or other sensors may make the system more efficient. Additionally, uncertainties may be identified and/or reduced to increase the odds of successfully going from seed to sale and gaining a satisfied customer that returns for purchases.

In some embodiments, a UAV may be configured to perform cross-purpose transport. For example, the system may anticipate needs such as fertilizers, and optimize the use of the UAV's transport capacity both ways. In some embodiments, the docking stations may comprise solar panel with autonomous UAV hookup on rooftops for near-autonomous off-the-grid functioning of UAVs. In some embodiments, a docking station may include retractable cover for sheltering UAVs from the weather. In some embodiments, a UAV and/or a docking station may comprise an autonomous system status checker that updates when asked or when a problem is detected.

In some embodiments, a UAV may be configured to leapfrog docking station chains to increase the coverage area of a single UAV. In some embodiments, the system may include rescue UAVs configured to recover other malfunctioned UAVs. In some embodiments, a UAV may comprise retractable “hawk wings” to leverage wind or thermals energy from fields for extended flying time and/or to leverage the wind for more efficient flight.

In some embodiments, a UAV may function as a “scarecrow” by producing animal deterring sounds. In some embodiments, a UAV may be configured to chasing birds away from the field. In some embodiments, a UAV may be configured to scare birds or repel insects using compressed air (via noise or air-pressure). In some embodiments, a UAV may be configured to recognize birds visually and take action to deter birds accordingly. In some embodiments, a UAV may be shaped like a hawk to scare away birds. In some embodiments, a UAV may comprise a sensor (e.g. radar) to detect birds approaching from a distance. In some embodiments, one or more UAVs may be configured to herd animals away from crops.

In some embodiments, a UAV may be configured to function as a targeted pollinator. In some embodiments, a UAV may comprise a precise automated navigation system, a mapping sensor, altitude control, and a pollen dispenser. In some embodiments, the pollen dispenser may use inkjet technology for dispensing pollen. In some embodiments, a UAV may drag a refillable pad or a light weight brush across flowers to aid in pollination. In some embodiments, the UAV may comprise a squirt gun configured to perform binding application targeted at flowers. In some embodiments, the UAV may be configured to automatically refill the pollen application. In some embodiments, a UAV may be configured to carry a tank of pollen on the UAV to supply the dispenser. In some embodiments, the pollen application may comprise indicators to identify whether a flower has been pollinated. For example, the indicators may be read similar to a radar scan and detected as hot spots. In some embodiments, pollen application may be detected based on visual analytics. In some embodiments, a combination of pollen and an agent (e.g. dye, chip) may be used to identify if the pollen has reached the flowers. In some embodiments, a UAV may comprise a sky-crane to lower the pollinator device(s) and may hover above the plants and not downwash on flowers. In some embodiments, the UAVs may comprise lighter than air hybrid UAV for stationary or slow moving operations such as 24/7 monitoring. In some embodiments, a UAV may be configured to perform post pollination quality checks based on image analysis. In some embodiments, the system may optimize the timing of pollination to avoid other sources of pollen and cross contamination.

In some embodiments, a UAV may comprise a precision insecticide dispenser. In some embodiments, a UAV may be call in when insects are detected in a field or in adjacent fields before they arrive in the home field. In some embodiments, the system may increase the efficiency and reduce the cost large scale organic farming. In some embodiments, the system may also reduce the effects of pesticides on the environment.

In some embodiments, the system may comprise air analyzers for detecting the presence of insects and/or pest animals (e.g. ground hog) based on bug expiration and/or odor of droppings. In some embodiments, a solar panel docking stations may create a perimeter around the farms to monitor the entire field as well as the air above it. In some embodiments, UAVs and other devices may function as a surrogate for the fence line and use a wireless connection (e.g. Wi-Fi) for sharing information. In some embodiments, the system may be configured to detect and identify pest profiles on leaves, stalks, etc. In some embodiments, the system may use audio data to identify pests.

In some embodiments, a solar panel may be added to an airship type UAVs for constant refueling and multi-use/purpose. In some embodiments, a UAV, a docking station, and/or a solar panel of the docking station may comprise a bug zapper curtain and/or may target pests on the fly. In some embodiments, a UAV, a docking station, and/or a solar panel may comprise an attractive agent to herd bugs and eliminate pests. In some embodiments, bodies of dead pests may be used for food for livestock and/or fertilizer.

In some embodiments, UAVs may comprise wings for gliding. In some embodiments, UAVs may comprise solar panels for longer flight time. In some embodiments, the system may comprise modularized sensor units configured to be attached to different types of vehicles. In some embodiments, sensor units may be removable from UAVs to reduce the weight of the UAV. In some embodiments, UAVs may be configured to have modules autonomously attached, removed, and/or reconfigured at a tooling station. In some embodiments, UAVs may comprise modularized receptor for various sensor configurations. In some embodiments, a UAV may comprise a retractable soil, weather, or water monitoring device. In some embodiments, a monitoring device may be attached to the UAV or may be configured to be shot into the soil and separated from the UAV.

In some embodiments, UAVs may be configured to handle some monitoring functions that do not require flight (e.g. weather monitoring) from the ground and/or a docking station. In some embodiments, UAVs may be configured to simultaneously monitor an area and gather of data in parallel. In some embodiments, soil, weather, and other types of conditions may be monitored at the same time. In some embodiments, a UAV and/or a docking station may perform topographical analysis to provide an accurate starting point for the delta. In some embodiments, a UAV may be configured to detect if a specific portion of an agricultural plot needs to be harvested. In some embodiments, a UAV may be used to slow the progression of a part of a plot. In some embodiments, field information may be relayed back to a central computer system and/or an operator, and farm vehicles may be directed to the location for harvesting.

In some embodiments, UAVs, whether stationed or in flight, may function as waypoints for other vehicles. In some embodiments, the system may comprise fixed nodes in the fields that can act as monitors and also relay information (e.g. location assistance) to the UAVs and other types of equipment. In some embodiments, UAVs may function as scouts in assisting workers who are harvesting or planting. In some embodiments, a UAV may be configured to detect weeds in a plot based on image analysis. In some embodiments, a UAV may be configured to dock with and/or undock from a tractor moving in the field.

In some embodiments, the system may be configured to optimize flight patterns by time and altitude for different monitoring functions. In some embodiments, a UAV may comprise retractable sails to optimize efficiency in vertical wind conditions.

In some embodiments, the system may perform bird identification and adjust its abilities based on those identifications. In some embodiments, animals may be identified based on trackers. In some embodiments, a UAV may be configured to remove the animal or pest from the field. In some embodiments, a UAV may use radar or detect for pests. In some embodiments, a UAV may proactively deter pests and/or use of weaponized devices (e.g. nets, pesticide, sprayer, cartage system, etc.) to combat pests and animals. In some embodiments, UAVs may be configured to herd and/or shepherd animals. In some embodiments, a UAV may be configured to interact with dogs and/or workers to assist in herding.

In some embodiments, a UAV may employ military-style silence technology to reduce the noise made by the UAV and allows for night UAV operations. In some embodiments, UAVs may be configured to produce audio or digital signal to notify customers of its arrival. In some embodiments, UAVs may function as before-the-first responder UAV in energy situations delivering such items as defibrillators and instructions when time is supercritical. In some embodiments, a UAV may provide first responders with an early video of the scene before responders arrive. In some embodiments, such UAVs may be pre-positioned well forward of first responder bases to respond to emergency situations.

In some embodiments, a functioning UAV that is somehow cut off between delivery and retrieval may be configured to hover at a fixed location and a fixed altitude (e.g. 7 feet) until retrieved. In some embodiments, a UAV may be equipped with dog deterring whistle. In some embodiments, UAVs may be configured to transport cross-inventory exchange between stores. In some embodiments, UAVs may comprise detachable rotors and motors that can be easily replaced in the field. In some embodiments, the system may send a verification ping to a smartphone to ensure someone is standing by for a delivery before a delivery UAV is launched.

In some embodiments, UAVs may use highways as path guidance as almost all delivery locations would have access to roads, people are used to items on roads making noise, roads a generally clear of obstacles spare some tunnels and city underpasses, and roads provides a unique fingerprint to find locations.

In some embodiments, UAVs may function as predator-deterring sentry units. In some embodiments, UAVs may tracks emitters from government collared predators (e.g. wolves and mountain lions) in national and state parks near farmland areas. In some embodiments, UAVs may be configured to UAV chases off predators that come too close using high-frequency whistles to reduce conflicts between farmer and predator animals. In some embodiments, UAVs may be configured to shepherd farm animals.

In some embodiments, UAVs may be configured for loss prevention in stores. In some embodiments, one or more UAVs may be hangs from above a store entryway. If a shoplifter leaves the store with a security-detected item, the UAV may drops from the roof and follow the shoplifter from about twelve feet up, flashing lights and taking video. In some embodiments, a customer may receive a warning that they are carrying a security-detected item before they step out the door.

In some embodiments, UAVs may be configured to escort customers out to their vehicle with lights and/or video recording. In some embodiments, the functions the system may be integrated into a shopping cart and/or a personal assistance device.

In some embodiments, UAVs may be configured to drop items (e.g. packages, sensors) via parachutes. In some embodiments, UAVs may be used to deploy fertilizers, determine yields for farmers, and forecast harvest to anticipate the needs for transport and provide accurate sourcing to different facilities within the supply chain to minimalize the discounting of produce and increase even distribution of products

In some embodiments, the system may comprise solar panel docking stations throughout a field so UAVs can charge while surveilling the field. In some embodiments, docking stations may comprise sensors for detecting one or more of moisture, sunlight, rainfall, temperature, etc.

In some embodiments, UAVs may be configured to deploy supplies to farmers in the field. In some embodiments, UAVs may be used to survey potential crop plots and analyze the ground beneath to increase crop plot usage efficiency. In some embodiments, UAVs may be configured to monitor and record human activity in the field. In some embodiments, UAVs may include visual analytic sensors configured to detect for abnormal activity in the field from one or more of humans, pets, and animals. In some embodiments, UAVs may be configured to deploy water. In some embodiments, UAVs may be configured to follow farm workers during harvesting to optimize harvest/plant route planning. In some embodiments, UAVs may transmit a route plan to workers that analyzes the worker's position and the harvest/plant route line to provide workers with an efficient crop harvesting and planting management plan.

In some embodiments, when a UAV loses connection or fails while operating, the UAV may deploy a parachute for landing. In some embodiments, a UAV parachute may be configured pulled back into the parachute housing at the top of the UAV. In some embodiments, the parachute may wrap around the UAV, including the propellers, and remain tight with tension by gear or other mechanism. In some embodiments, a failed UAV may transmit a homing beacon to a central computer or a docking station and sit wrapped and secured until help arrives.

In some embodiments, UAVs may be configured to track marine wildlife. In some embodiments, sizes, paths, and locations of marine wildlife may be tracked with UAVs. Information of marine life sighting may be relayed to officials in near real time. In some embodiments, UAVs may be configured to shoot RFID chips from the air and tag wildlife. In some embodiments, UAVs may further monitor shorelines and boating paths. In some embodiments, UAVs may also detect for swimmers in distress. In some embodiments, UAVs may include flexible wings that may adjust to wind streams, much like sailboats. In some embodiments, UAVs may further monitors for drug trafficking, perform search and rescue, and/or provide lifeguard services. In some embodiments, a UAV may be configured to deploy a parachute and/or a raft when it fails over water or land to reduce the damage sustained from impact.

In some embodiments, UAVs may be used to track containers waiting for customs processing in a port area to detect for congestions at the port and get early formation for potential impacts on resources and supply chain. In some embodiments, UAVs may be used to conduct temperature management for the containers and/or monitor the cold chain/chilled chain.

In some embodiments, UAVs may be used to check that a fence around the property is not damaged. In some embodiments, UAVs may be used to check on the well-being of the animals, such as cattle, horses. In some embodiments, a UAV may be configured to detect that another UAV is deliberately attempting to fly into it and maneuver to avoid damage. In some embodiments, a UAV may be configured to time the application fertilizer to control the peak harvest time based on the expected peak price for the commodity.

In one embodiment, a system for unmanned flight optimization comprises a flight system configured to provide locomotion to an unmanned aerial vehicle, a sensor system on the unmanned aerial vehicle, and a control circuit coupled to the flight system and the sensor system. The control circuit being configured to: retrieve a task profile for a task assigned to the unmanned aerial vehicle, detect condition parameters of the unmanned aerial vehicle based on the sensor system, determine whether to station the unmanned aerial vehicle based on the task profile and the condition parameters, and deactivate the flight system of the unmanned aerial vehicle while the unmanned aerial vehicle performs the task.

In one embodiment, a method for unmanned flight optimization comprises retrieving, at a control circuit, a task profile for a task assigned to an unmanned aerial vehicle comprising a flight system and a sensor system, detecting condition parameters of the unmanned aerial vehicle based on the sensor system, determining, with the control circuit, whether to station the unmanned aerial vehicle based on the task profile and the condition parameters, and deactivating the flight system of the unmanned aerial vehicle while the unmanned aerial vehicle performs the task.

In one embodiment, an apparatus for unmanned flight optimization, comprising: a non-transitory storage medium storing a set of computer readable instructions, and a control circuit configured to execute the set of computer readable instructions which causes to the control circuit to: retrieve a task profile for a task assigned to an unmanned aerial vehicle comprising a flight system and a sensor system, detect condition parameters of the unmanned aerial vehicle based on the sensor system, determine whether to station the unmanned aerial vehicle based on the task profile and the condition parameters, and deactivate the flight system of the unmanned aerial vehicle while the unmanned aerial vehicle performs the task.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for managing unmanned flight task performance and flight comprising:
a flight system configured to provide locomotion to an unmanned aerial vehicle;
a sensor system on the unmanned aerial vehicle; and
a control circuit coupled to the flight system and the sensor system, the control circuit being configured to:
retrieve a task profile for a task assigned to the unmanned aerial vehicle;
detect condition parameters of the unmanned aerial vehicle based on the sensor system;
determine whether, under the condition parameters, the task can be performed while the unmanned aerial vehicle is stationed based on the task profile; and
in the event that the task can be performed while the unmanned aerial vehicle is stationed, station the unmanned aerial vehicle and deactivate the flight system of the unmanned aerial vehicle while the unmanned aerial vehicle performs the task.

2. The system of claim 1, wherein the control circuit is further configured to:
cause the flight system to land the unmanned aerial vehicle in an event that the unmanned aerial vehicle is currently in flight.

3. The system of claim 1, wherein the control circuit is further configured to:
determine a landing location for the unmanned aerial vehicle; and
cause the flight system to fly the unmanned aerial vehicle to the landing location for landing.

4. The system of claim 3, wherein the landing location comprises one or more of a docking station, a charging station, a ground location, an elevated observation location, and a motored vehicle.

5. The system of claim 1, further comprising a docking mechanism configured to couple the unmanned aerial vehicle with one or more of a docking station, a charging station, and a motored vehicle.

6. The system of claim 1, wherein the control circuit is further configured to:
detect updated condition parameters while the unmanned aerial vehicle is stationed; and
select a new landing location based on the updated condition parameters.

7. The system of claim 1, wherein whether to station the unmanned aerial vehicle is determined based on satisfying requirements of the task profile while minimizing power consumption of and risk to the unmanned aerial vehicle.

8. The system of claim 1, wherein the condition parameters comprises one or more of: wind speed, visibility, lighting condition, precipitation, weather condition, ground condition, landing site availability, animal presence, human presence, and distance to a charging station.

9. The system of claim 1, wherein the task profile comprises one or more requirements for task accuracy, acceptable risk, distance to a task location, data to be collected, action to be performed, and required modular attachments.

10. The system of claim 1, wherein whether to station the unmanned aerial vehicle is determined further based on one or more of a fuel level, attached equipment type, flight capability, other assigned tasks of the unmanned aerial vehicle, and tasks assigned to a system of manned or unmanned vehicles.

11. A method for managing unmanned flight task performance and flight comprising:
retrieving, at a control circuit, a task profile for a task assigned to an unmanned aerial vehicle comprising a flight system and a sensor system;
detecting condition parameters of the unmanned aerial vehicle based on the sensor system;
determining, with the control circuit, whether under the condition parameters, the task can be performed while the unmanned aerial vehicle is stationed based on the task profile; and
in the event that the task can be performed while the unmanned aerial vehicle is stationed, stationing the unmanned aerial vehicle and deactivating the flight system of the unmanned aerial vehicle while the unmanned aerial vehicle performs the task.

12. The method of claim 11, further comprising:
causing the flight system to land the unmanned aerial vehicle in an event that the unmanned aerial vehicle is currently in flight.

13. The method of claim 11, further comprising:
determining a landing location for the unmanned aerial vehicle; and
causing the flight system to fly the unmanned aerial vehicle to the landing location for landing.

14. The method of claim 13, wherein the landing location comprises one or more of a docking station, a charging station, a ground location, an elevated observation location, and a motored vehicle.

15. The method of claim 11, further comprising:
coupling the unmanned aerial vehicle with one or more of a docking station, a charging station, and a motored vehicle via a docking mechanism.

16. The method of claim 11, further comprising:
detecting updated condition parameters while the unmanned aerial vehicle is stationed; and
selecting a new landing location based on the updated condition parameters.

17. The method of claim 11, wherein whether to station the unmanned aerial vehicle is determined based on satisfying requirements of the task profile while minimizing power consumption of and risk to the unmanned aerial vehicle.

18. The method of claim 11, wherein the condition parameters comprises one or more of: wind speed, visibility, lighting condition, precipitation, weather condition, ground condition, landing site availability, animal presence, human presence, and distance to a charging station.

19. The method of claim 11, wherein the task profile comprises one or more requirements for task accuracy, acceptable risk, distance to a task location, data to be collected, action to be performed, and required modular attachments.

20. The method of claim 11, wherein whether to station the unmanned aerial vehicle is determined further based on one or more of a fuel level, attached equipment type, flight capability, other assigned tasks of the unmanned aerial vehicle, and tasks assigned to a system of manned or unmanned vehicles.

21. An apparatus for managing unmanned flight task performance and flight, comprising:
a non-transitory storage medium storing a set of computer readable instructions; and
a control circuit configured to execute the set of computer readable instructions which causes to the control circuit to:
retrieve a task profile for a task assigned to an unmanned aerial vehicle comprising a flight system and a sensor system;
detect condition parameters of the unmanned aerial vehicle based on the sensor system;
determine whether, under the condition parameters, the task can be performed while the unmanned aerial vehicle is stationed based on the task profile; and
in the event that the task can be performed while the unmanned aerial vehicle is stationed, station the unmanned aerial vehicle and deactivate the flight system of the unmanned aerial vehicle while the unmanned aerial vehicle performs the task.
